(19) United States
(12) Patent Application Publication
(10) Pub. No.: US 2014/0232726 A1
(43) Pub. Date: Aug. 21, 2014

(54) SPACE-FILLING CURVE PROCESSING SYSTEM, SPACE-FILLING CURVE PROCESSING METHOD, AND PROGRAM

(71) Applicant: NEC CORPORATION, Tokyo (JP)

(72) Inventor: Shinji Nakadai, Tokyo (JP)

(73) Assignee: NEC CORPORATION, Tokyo (JP)

(21) Appl. No.: 14/347,723

(22) PCT Filed: Sep. 26, 2012
(86) PCT No.: PCT/JP2012/006154

§ 371 Date: Mar. 27, 2014

(30) Foreign Application Priority Data
Sep. 27, 2011 (JP) 2011-211144

(51) Int. Cl. G06T 11/20

(52) U.S. Cl. CPC G06T 11/203
USPC 345/440

(57) ABSTRACT

A space-filling curve processing system includes a data density acquisition unit (104) that, when performing processing on a subspace of a multi-dimensional space, refers to distribution information indicating the density distribution or cumulative distribution of a data constellation of a plurality of one-dimensional values obtained by performing space-filling curve processing on multi-dimensional data associated with a processing objective, and acquires the data density of a one-dimensional value or range corresponding to the subspace, a determination unit (106) that determines whether to perform space-filling curve processing in accordance with the data density of the subspace, and a space-filling curve processing unit (108) that performs the space-filling curve processing in accordance with a determination result of the determination unit (106).

### TECHNICAL FIELD

The present invention relates to a space-filling curve processing system, a space-filling curve processing method, and a program.

### BACKGROUND ART

An example of space-filling curve processing is disclosed in Non-Patent Document 1. In the space-filling curve processing method disclosed in Non-Patent Document 1, using a multi-dimensional attribute range as an input, all blocks in which data included in the range is stored are listed using a state transition table for performing the conversion of a space-filling curve. The term “block” means a portion of an area of a physical disk having data stored thereon. Multi-dimensional data having a continuous one-dimensional range by a space-filling curve is stored in one block. That is, values obtained by one-dimensionalizing multi-dimensional attribute values are used as keys, and are continuously stored in the block in that order. When blocks having data, belonging to a provided multi-dimensional attribute range, stored thereon are listed, it is sequentially determined whether each block is included in a provided multi-dimensional attribute range while referring to a one-dimensional value serving as the segmentation of the block. When the block is included therein, the block is included in a result, and when the block is not included therein the next block is searched.

### RELATED DOCUMENT

### Patent Document

[Patent Document 1] Japanese Unexamined Patent Application Publication No. 2008-234563

[Non-Patent Document 1] J. K. Lawder, and one other, “Using Space-Filling Curves for Multi-dimensional Indexing”, Advances in Databases: proceedings of the 17th British National Conference on Databases (BNCOD 17), Lecture Notes in Computer Science (LNCS), volume 1832, 2000, pp.20-35

### SUMMARY OF THE INVENTION

In a technique disclosed in the above Document, it is possible to list blocks having data, belonging to a specified multi-dimensional attribute range, stored thereon. However, when a plurality of one-dimensional ranges corresponding to the specified multi-dimensional attribute range are processed, there has been a problem in that it takes time for processing of high dimensions or long bit lengths, at the time of performing space-filling curve processing on the multi-dimensional attribute range (subspace of a multi-dimensional space). The reason is as follows. Since only determination of whether a one-dimensional range of which the block takes charge and a multi-dimensional attribute range obtained by a retrieval expression intersect each other has been required at the time of listing the blocks, processing has been simplified. However, when a plurality of one-dimensional ranges corresponding to the provided multi-dimensional range are processed individually, the number of one-dimensional ranges corresponding to one multi-dimensional attribute range are two or more, and the number increases exponentially with respect to the number of dimensions and the bit length. Therefore, it takes time to perform processing.

An object of the invention is to provide a space-filling curve processing system, a space-filling curve processing method, and a program which are capable of solving a high load of space-filling curve processing which is the above-mentioned problem.

According to the present invention, there is provided a space-filling curve processing system including: an acquisition unit that, when performing processing of an objective on a subspace of a multi-dimensional space, refers to distribution information indicating density distribution or cumulative distribution of a data constellation of a plurality of one-dimensional values obtained by performing space-filling curve processing on multi-dimensional data associated with the processing objective, and acquires data density of a one-dimensional value or range corresponding to the subspace; a determination unit that determines whether to perform space-filling curve processing in accordance with the acquired data density of the subspace; and a space-filling curve processing unit that performs the space-filling curve processing in accordance with a determination result of the determination unit.

According to the present invention, there is provided a space-filling curve processing method in which a data processing device that performs space-filling curve processing on multi-dimensional data associated with a processing objective, the space-filling curve processing method comprising: referring to, by the data processing device, when performing processing on a subspace of a multi-dimensional space, distribution information indicating density distribution or cumulative distribution of a data constellation of a plurality of one-dimensional values obtained by performing the space-filling curve processing on the multi-dimensional data, so as to acquire data density of a one-dimensional value or range corresponding to the subspace; determining, by the data processing device, whether to perform space-filling curve processing in accordance with the data density of the subspace; and performing, by the data processing device, space-filling curve processing in accordance with the determination result.

According to the present invention, there is provided a computer program causing a computer for realizing a data processing device that performs space-filling curve processing to execute: a procedure for, when performing processing of an objective on a subspace of a multi-dimensional space, referring to distribution information indicating density distribution or cumulative distribution of a data constellation of a plurality of one-dimensional values obtained by space-filling curve processing on multi-dimensional data associated with the processing objective, and acquiring data density of a one-dimensional value or range corresponding to the subspace; a procedure for determining whether to perform space-filling curve processing in accordance with the data density of the subspace; and a procedure for performing the space-filling curve processing in accordance with a determination result of the determination procedure.

Meanwhile, note that those obtained by converting any combination of the foregoing components and the representation of the present invention between a method, a device, a system, a recording medium, a computer program, and the like are also effective as aspects of the present invention.

In addition, various types of components of the present invention are not necessarily required to be present individually and independently, but a plurality of components may be formed as one member, one component may be formed by a plurality of members, a certain component may be a portion of another component, a portion of a certain component and a portion of another component may overlap each other, or the like.

In addition, a plurality of procedures are described in order in the method and the computer program of the present invention, but the order of the description is not intended to limit the order of the execution of the plurality of procedures. Therefore, when the method and the computer program of the present invention are executed, the order of the plurality of procedures can be changed within the range of not causing any problem in terms of the contents.

Further, the plurality of procedures of the method and the computer program of the present invention are not limited to be individually executed at timings different from each other. Therefore, another procedure may occur during the execution of a certain procedure, the execution timing of a certain procedure and a portion or all of the execution timings of another procedure may overlap each other, or the like.

According to the present invention, it is possible to provide a space-filling curve processing system, a space-filling curve processing method, and a program which are capable of realizing efficient processing while suppressing deterioration in the accuracy of processing.

### BRIEF DESCRIPTION OF THE DRAWINGS

The above-mentioned objects, other objects, features and advantages will be made clearer from the preferred embodiments described below, and the following accompanying drawings.

FIG. 1 is a functional block diagram illustrating main components of a data processing device of a space-filling curve processing system according to an embodiment of the present invention.

FIG. 2 is a state transition diagram illustrating conversion rules usable in space-filling curve processing in the space-filling curve processing system according to the embodiment of the present invention.

FIG. 3 is a functional block diagram illustrating a configuration of the data processing device of the space-filling curve processing system according to the embodiment of the present invention.

FIG. 4 is a diagram in which a relationship between a multi-dimensional space and a subspace in the space-filling curve processing of the space-filling curve processing system according to the embodiment of the present invention as represented in a tree structure.

FIG. 5 is a diagram illustrating an example of a format of distribution information of a data constellation in the space-filling curve processing system according to the embodiment of the present invention.

FIG. 6 is a diagram illustrating an example of a format of distribution information of a data constellation in the space-filling curve processing system according to the embodiment of the present invention.

FIG. 7 is a diagram illustrating an example of a format of distribution information of a data constellation in the space-filling curve processing system according to the embodiment of the present invention.

FIG. 8 is a diagram illustrating an example of a format of distribution information of a data constellation in the space-filling curve processing system according to the embodiment of the present invention.

FIG. 9 is a flow diagram illustrating an example of a procedure of a distribution information generation process of the data processing device of the space-filling curve processing system according to the embodiment of the present invention.

FIG. 10 is a flow diagram illustrating an example of a procedure of the space-filling curve processing of the data processing device of the space-filling curve processing system according to the embodiment of the present invention.

FIG. 11 is a diagram illustrating operations of the space-filling curve processing system according to the embodiment of the present invention.

FIG. 12 is a diagram illustrating a specific example of space-filling curve processing of multi-dimensional range retrieval in a comparative example to the present invention.

FIG. 13 is a diagram illustrating a specific example of data distribution and space-filling curve processing assumed in an example of the present invention.

FIG. 14 is a diagram illustrating a specific example of data distribution and space-filling curve processing assumed in the example of the present invention.

FIG. 15 is a diagram illustrating a specific example of data distribution and space-filling curve processing assumed in the example of the present invention.

### DESCRIPTION OF EMBODIMENTS

Hereinafter, embodiments of the present invention will be described with reference to the accompanying drawings. In all the drawings, like elements are referenced by like reference numerals and descriptions thereof will not be repeated.

### First Embodiment

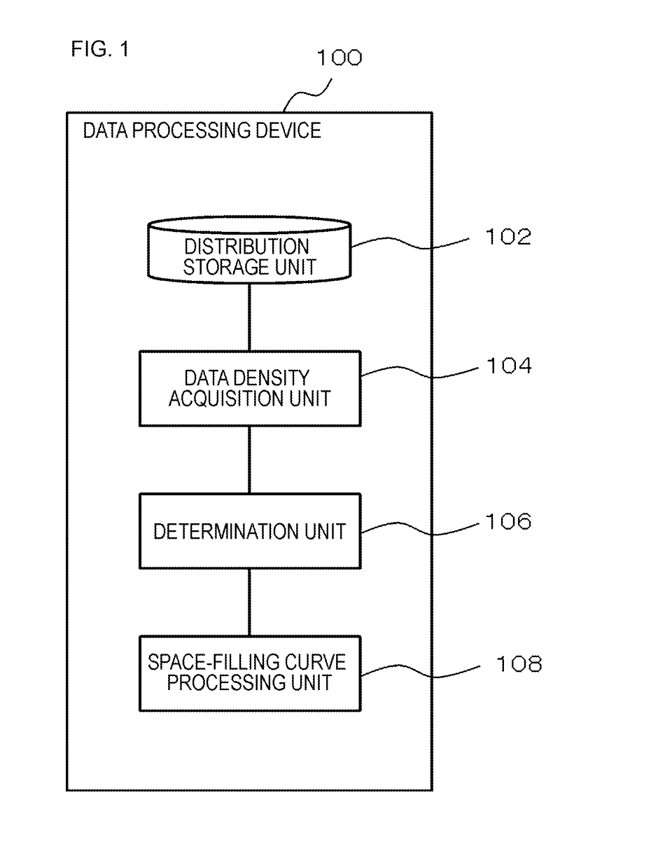

FIG. 1 is a functional block diagram illustrating a configuration of a data processing device 100 of a space-filling curve processing system according to an embodiment of the present invention.

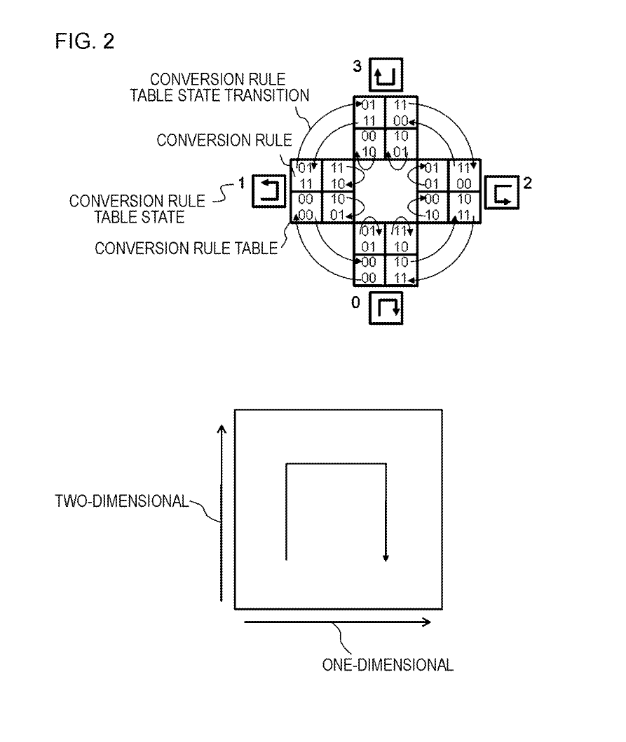

Space-filling curve processing is a process of one-dimensionalizing a multi-dimensional attribute data constellation, and using, for example, one multi-dimensional attribute value in the data constellation as an input, a corresponding one-dimensional value is output in the processing. At the time of conversion, a conversion rule table, shown in FIG. 2, according to the number of dimensions to be converted may be used. This conversion rule table is expressed as transition between a plurality of conversion rule table states, and is table in which, using the combination of respective dimension values in a bit position from a certain head bit during a certain conversion rule state as an input, the combination of a conversion rule state of the next transition destination with a corresponding one-dimensional value is output.

When a set of values one-dimensionalized by the space-filling curve processing is managed in a block unit corresponding to one one-dimensional range, it is not necessary to individually process a plurality of one-dimensional ranges corresponding to a provided multi-dimensional range in order to list blocks intersecting a provided multi-dimensional attribute range. Further, in this case, it is possible to achieve efficiency by determining only whether the provided multi-dimensional range and the block intersect each other while referring to an end point of the one-dimensional range of each block. However, when a plurality of one-dimensional ranges corresponding to the provided multi-dimensional range are required to be individually processed, the space-filling curve processing increases in the number of spaces to be processed and the amount of calculation in a case where the number of dimensions and the number of bits are large.

In the space-filling curve processing system according to the embodiment of the present invention, when the space-filling curve processing is performed, each data item of a data set associated with the processing is previously set to a one-dimensional value in the space-filling curve processing, and distribution information of the set of one-dimensional values is generated. Processing for a subspace of a space-filling curve is performed while referring to the distribution information, thereby allowing the data density of the subspace to be estimated. When the data density is smaller than a certain reference, it is possible not to perform processing of the subspace. Thereby, even when processing of the space itself finer than the block is required, it is possible to realize the speeding up of processing while keeping deterioration in the accuracy of processing small.

The space-filling curve processing system according to the embodiment of the present invention can be used as an event driving system which conditions multi-dimensional range retrieval or a multi-dimensional attribute value, in a database system, a data stream system, a Pub/Sub (Publish/Subscribe) system, or the like. In addition, the space-filling curve processing system according to the embodiment of the present invention can also be used in performing selectivity estimation before data retrieval is performed at the time of determining the execution sequence of a complicated retrieval expression.

As shown in FIG. 1, the space-filling curve processing system according to the embodiment of the present invention includes a data density acquisition unit 104 that, when performing processing of an objective on a subspace of a multi-dimensional space, refers to distribution information indicating the density distribution or cumulative distribution of a data constellation of a plurality of one-dimensional values obtained by performing space-filling curve processing on multi-dimensional data associated with the processing objective, and acquires the data density of a one-dimensional value or range corresponding to the subspace, a determination unit 106 that determines whether to perform space-filling curve processing in accordance with the data density of the subspace, and a space-filling curve processing unit 108 that performs the space-filling curve processing in accordance with a determination result of the determination unit 106.

The data processing device 100 of the present embodiment can be realized, for example, by a server computer and a personal computer, or devices which are equivalent to these computers.

In addition, in each of the following drawings, the configurations of portions irrelevant to the essence of the present invention are not repeated and not shown.

In addition, each component of the data processing device 100 according to the present embodiment is realized by any combination of hardware and software of any computer (not shown) which includes a CPU (Central Processing Unit), a memory, a program loaded to the memory and implementing the constitutional elements of each drawing, a storage unit, such as a hard disk, which stores the program, and an interface for network connection. It will be understood to those skilled in the art that there are various modified examples in the realization method thereof and the devices. Each drawing described below shows a block of a functional unit rather than the configuration of a hardware unit.

The program stored in the hard disk is read out to the memory and executed by the CPU of the computer, thereby allowing each function of each unit in each drawing of the data processing device 100 to be realized.

In the data processing device 100 of the present embodiment, various processing operations corresponding to the computer program are executed by the CPU, and thus various units described in the present embodiment are realized as various functions.

The computer program of the present embodiment is described so as to cause a computer for realizing the data processing device 100 that performs space-filling curve processing to execute, when performing processing on a subspace of a multi-dimensional space, a procedure for referring to distribution information indicating the density distribution or cumulative distribution of a data constellation of a plurality of one-dimensional values obtained by performing space-filling curve processing on multi-dimensional data associated with a processing objective, and acquiring the data density of a one-dimensional value or range corresponding to the subspace, a procedure for determining whether to perform space-filling curve processing in accordance with the data density of the subspace, and a procedure for performing the space-filling curve processing in accordance with a determination result of the determination procedure.

The computer program of the present embodiment may be recorded in a computer readable recording medium. The recording medium is considered to have various forms without being particularly limited. In addition, the program may be loaded from the recording medium into a memory of a computer, and may be downloaded in a computer through a network and loaded into a memory.

Specifically, the space-filling curve processing system of the present embodiment includes the data processing device 100 provided with a distribution storage unit 102, a data density acquisition unit 104, a determination unit 106, and a space-filling curve processing unit 108.

The distribution storage unit 102 stores distribution information indicating the density distribution or cumulative distribution of a data constellation of a plurality of one-dimensional values obtained by performing space-filling curve processing on multi-dimensional data associated with a processing objective.

When performing processing of an objective on a subspace of a multi-dimensional space, the data density acquisition unit 104 acquires the data density of a one-dimensional value or range corresponding to the subspace.

When performing the processing of an objective on the subspace of the multi-dimensional space, the determination unit 106 determines whether to perform space-filling curve processing in accordance with the data density of the subspace acquired by the data density acquisition unit 104.

When performing the processing of an objective on the subspace of the multi-dimensional space, the space-filling curve processing unit 108 performs space-filling curve processing in accordance with the determination result of the determination unit 106.

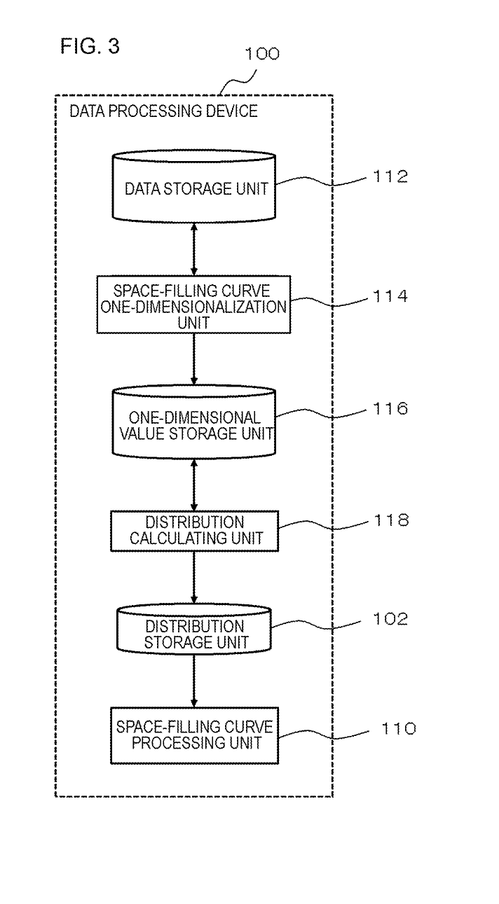

In addition, as shown in FIG. 3, the data processing device 100 of the space-filling curve processing system according to the present embodiment can further include a data storage unit 112, a space-filling curve one-dimensionalization unit 114, a one-dimensional value storage unit 116, and a distribution calculating unit 118, as components for generating the distribution information stored in the distribution storage unit 102. In another embodiment, the distribution information maybe information provided from another system or existing information.

As shown in FIG. 3, the data processing device 100 includes a space-filling curve processing unit 110 provided with the data density acquisition unit 104, the determination unit 106, and the space-filling curve processing unit 108 which are shown in FIG. 1, and a distribution storage unit 102 shown in FIG. 1.

In the data storage unit 112, for example, at least a portion of a multi-dimensional attribute data constellation serving as a processing objective in the system, or a data constellation having similar distribution information is provided and stored as a sample in advance.

Using one multi-dimensional attribute value as an input, the space-filling curve one-dimensionalization unit 114 outputs a corresponding one-dimensional value. At the time of the conversion thereof, a conversion rule table according to the number of dimensions to be converted as mentioned with reference to FIG. 2 may be used.

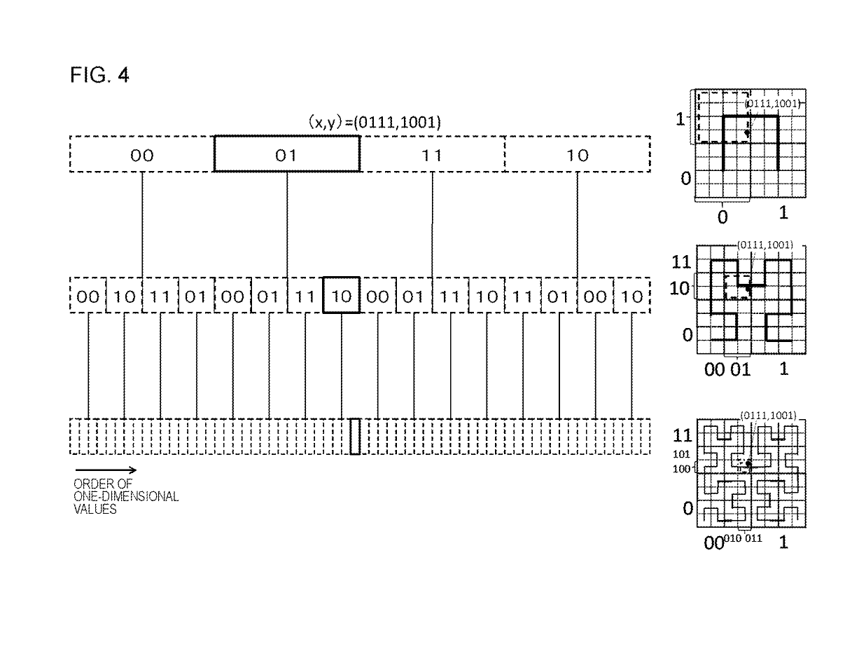

FIG. 4 shows an example of a conversion process using the conversion rule table of FIG. 2. FIG. 4 shows a tree structure in which a head bit is set to a root, and a low-order bit is set to a leaf. In the drawing, a state is drawn in which branching into different branches is performed in accordance with each bit having a multi-dimensional attribute value, and the tree structure after conversion advances to the branches with the advance from the head bit to the low-order bit. Meanwhile, a value noted in each branch is a multi-dimensional value of a certain bit, and expresses a one-dimensional value after conversion in terms of distance from the left end thereof.

For example, when multi-dimensional data values are (x, y)=(7, 9), these values are expressed as (0111, 1001) by 2-bit notation. An initial state is set to state 0, and (0, 1) which is the combination of each dimension of the head bit is input hereto. A one-dimensional value corresponding to the upper left having an upper multi-dimensional value of 01 in state 0 of FIG. 2 is 01, and the transition destination is state 0. Regarding the multi-dimensional value of 10 in state 0 corresponding to (1, 0) which is the combination of each dimension of a second bit from the next head, the one-dimensional value is 11, and the transition destination is 2.

Here, the obtained one-dimensional value is added to a low-order bit of the one-dimensional value of 01 obtained in advance, and 0111 is a one-dimensional value in this state. Subsequently, regarding the multi-dimensional value of 10 in state 2 corresponding to (1, 0) which is the combination of each dimension of a third bit from the head, the one-dimensional value is 11, and is set to be in state 0. In this manner, the space-filling curve one-dimensionalization unit 114 outputs a one-dimensional value corresponding to a multi-dimensional attribute value from the one-dimensional value obtained in each bit.

The one-dimensional value storage unit 116 stores the one-dimensional value which is output by the space-filling curve one-dimensionalization unit 114.

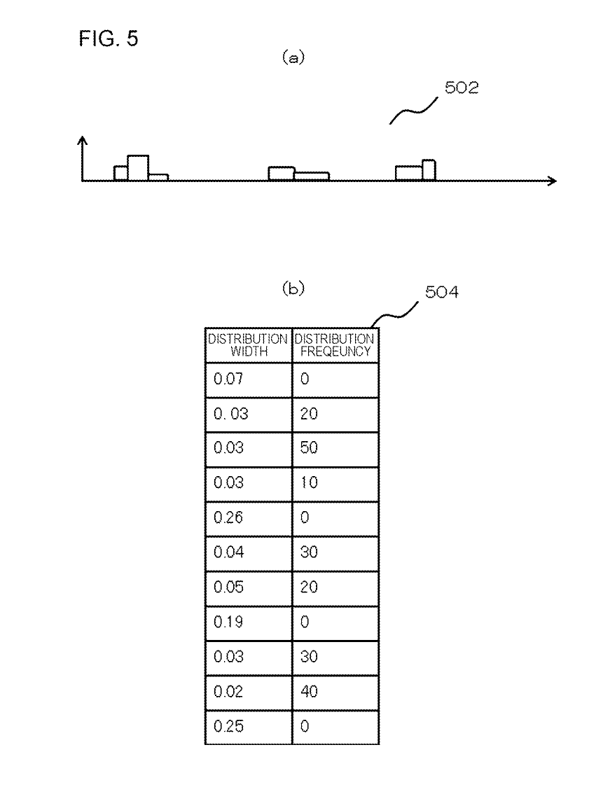

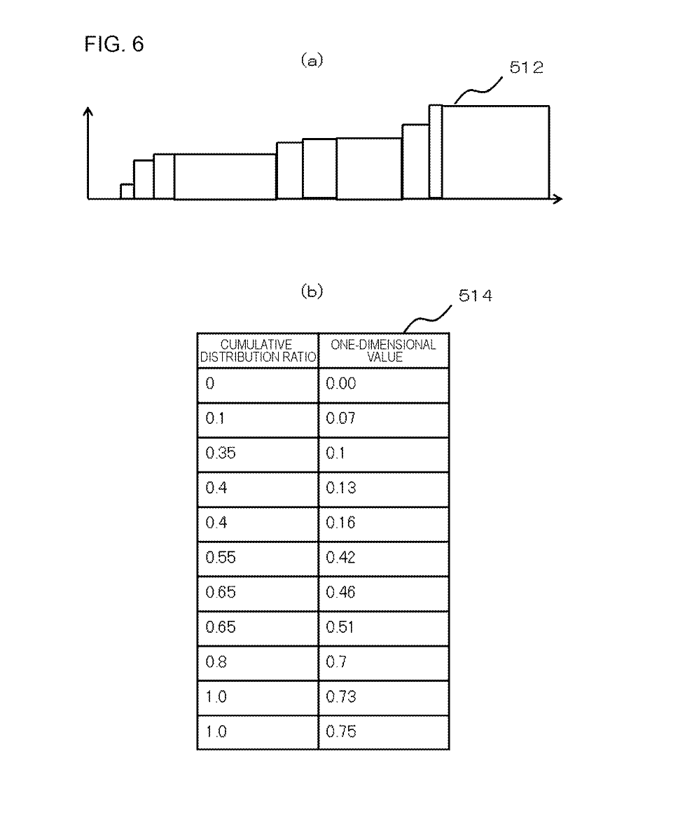

Using, as an input, a data constellation of a plurality of one-dimensional values obtained by performing space-filling curve processing on multi-dimensional data associated with a processing objective, the distribution calculating unit 118 generates distribution information indicating the density distribution or cumulative distribution of the data constellation. That is, the distribution calculating unit 118 generates distribution information of a plurality of data items stored in the one-dimensional value storage unit 116 from the data items. The distribution information generated herein may be density distribution (502 of FIG. 5(a)) indicating data density in a certain value, and may be cumulative distribution (512 of FIG. 6(a)) indicating a data ratio equal to or less than a certain value. The generated distribution information is stored in the distribution storage unit 102.

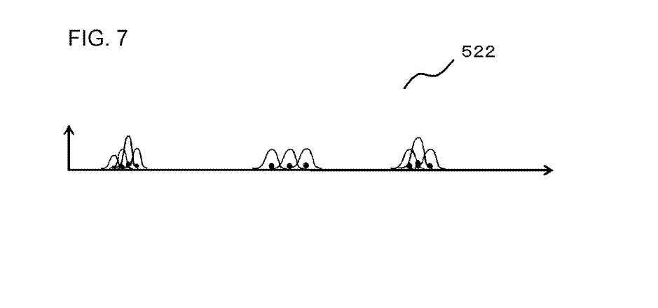

In addition, as a storage format, a method (522 of FIG. 7) of representing a distribution from stored original data and any function like the Kernel density function method may be used. In that case, the storage format is constituted by original data, a function and parameters. Alternatively, the storage format may be generated and stored as a format of managing frequency or cumulative distribution for the range of a certain value as expressed by table 504 of a histogram shown in FIG. 5(b) or table 514 of a histogram shown in FIG. 6(b).

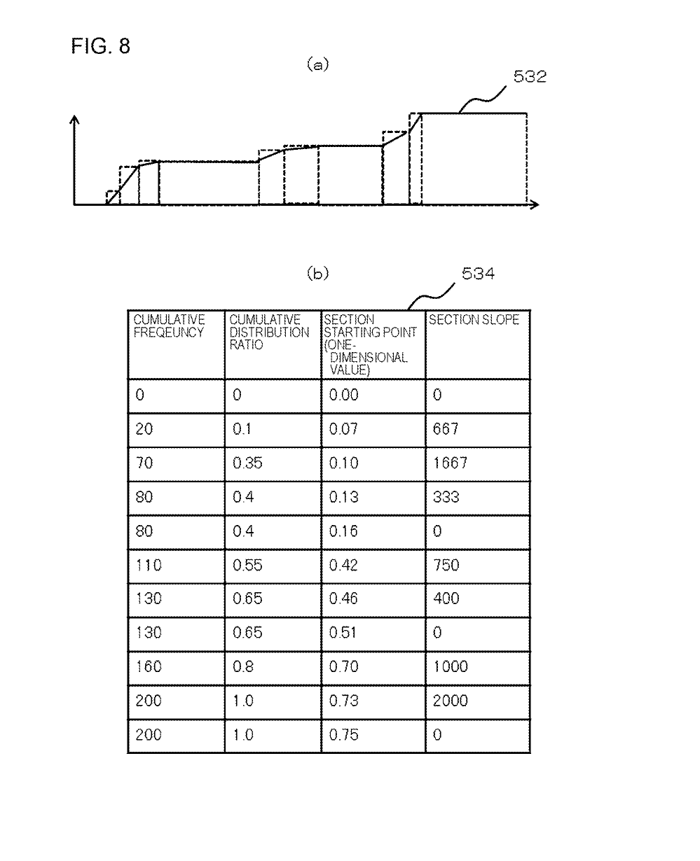

In addition, as another format, in order to input a certain value and easily obtain density or cumulative density in the value, a linear function may be obtained by setting a histogram to the slope of a section, and may be held as a format of the obtained linear function (graph 532 of FIG. 8(a) and table 534 of FIG. 8(b)).

Referring back to FIG. 3, when performing processing of the provided multi-dimensional attribute subspace, the space-filling curve processing unit 110 refers to the distribution information stored in the distribution storage unit 102, performs space-filling curve processing in accordance with the data density, and outputs an objective processing result.

In a process of subdividing each subspace of the multi-dimensional space and repeatedly performing the space-filling curve processing in a stepwise manner, the space-filling curve processing unit 110 performs subdivision in a stepwise manner only on each subspace of which the data density is equal to or more than a threshold, and repeats the space-filling curve processing a predetermined number of times. The space-filling curve processing unit 110 then stops the space-filling curve processing without performing further subdivision on each subspace of which the data density is less than a threshold.

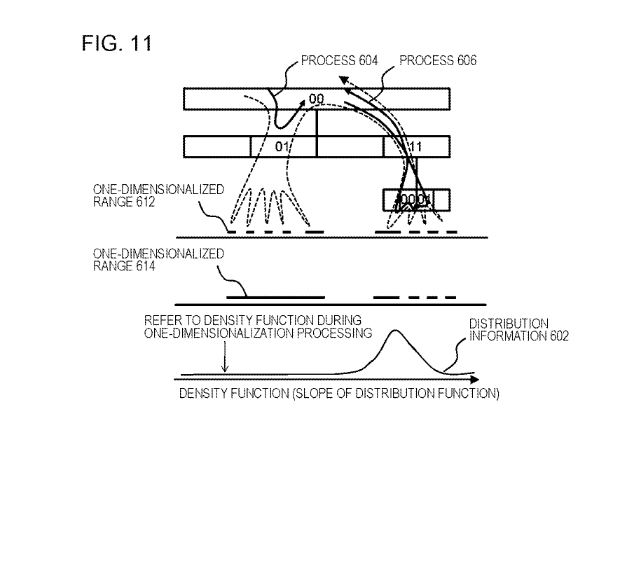

The space-filling curve processing unit 110 refers to the conversion rule table of FIG. 2, and performs processing corresponding to the subspace of the multi-dimensional space provided as an input while advancing from the combination of head bits of respective dimensions to a low-order bit (FIG. 11). When determining whether to advance a pointer indicating a location during processing within the multi-dimensional space to a lower bit position, the data density acquisition unit 104 of FIG. 1 obtains a one-dimensional value or a one-dimensional value range corresponding to a multi-dimensional value or range indicated by the pointer, refers to distribution information 602 of the distribution storage unit 102 of FIG. 1, and acquires data density corresponding to the value or range.

The determination unit 106 of FIG. 1 determines whether the data density is small in a certain fixed rule. When it is determined that the data density is small in the certain fixed rule in accordance with the determination result, the space-filling curve processing unit 110 of FIG. 3 does not perform the processing of advance to lower position (process 604 of FIG. 11). When it is determined that the data density is large in the certain rule, the processing of advance to lower position is performed (process 606 of FIG. 11).

The one-dimensionalized range which is obtained by the space-filling curve processing unit 110 of the present embodiment becomes the same as a range 614 of FIG. 11. On the other hand, the one-dimensionalized range which is obtained in a case where processing is advanced up to a uniformly predetermined depth without performing determination based on the data density becomes the same as a range 612 of FIG. 11. In an area having a high density in the distribution information 602 of the density distribution, the range 612 and the range 614 are searched at the same granularity. However, in an area having low density, a search at a coarse grain level is performed without performing a search at a fine grain level in the range 612, and the processing result is expressed as an approximate result.

Processing performed on a subspace of a multi-dimensional space provided as an input by the space-filling curve processing unit 110 is specifically as follows.

(a) Processing of acquiring a plurality of one-dimensional value ranges corresponding to a provided multi-dimensional range in order to perform multi-dimensional range retrieval

(b) Processing of acquiring neighboring data from a provided multi-dimensional attribute value by ordering one-dimensional ranges in order to perform a nearest neighbor search acquired by a specified number

(c) Processing of acquiring a total of range widths of the plurality of one-dimensional value ranges corresponding to the provided multi-dimensional range in order to estimate the selectivity of the multi-dimensional range retrieval

(d) Processing of acquiring a certain specified dimension value and the data density or the amount of data thereof in order to perform histogram display for visualizing multi-dimensional attribute distribution

When processing for the subspace of the multi-dimensional space is a retrieval process of acquiring a plurality of one-dimensional attribute values or ranges corresponding to a multi-dimensional attribute value or range, the space-filling curve processing unit 110 obtains, as retrieval ranges, each subspace in which space-filling curve processing is stopped in accordance with data density and each subspace which is obtained by performing the space-filling curve processing a predetermined number of times.

Each unit of the data processing device 100 operates roughly as follows.

From a multi-dimensional attribute data set associated with the processing objective stored in the data storage unit 112, with respect to all or some of data elements of the set, each data item is one-dimensionalized by performing space-filling curve processing in the space-filling curve one-dimensionalization unit 114, and the data set is stored in the one-dimensional value storage unit 116. Subsequently, the distribution calculating unit 118 generates distribution information (histogram) from the data set stored in the one-dimensional value storage unit 116, and stores the generated information in the distribution storage unit 102. In this manner, the distribution information is generated and is stored in the distribution storage unit 102.

When processing of the provided multi-dimensional attribute subspace is performed, the space-filling curve processing unit 110 refers to the distribution information stored in the distribution storage unit 102, and outputs an intended processing result of the space-filling curve processing unit 110.

Specifically, when a plurality of one-dimensional ranges that satisfy a condition for the subspace of the provided multi-dimensional space are processed, a search from a root node (corresponding to a multi-dimensional head bit) of the state transition table indicating space-filling curve processing to a leaf node (low-order bit) is performed. While searching, density corresponding to a search area is obtained on the basis of the search pointer and the histogram stored in the distribution storage unit 102. For example, a one-dimensional range determined from a one-dimensional value and tree hierarchy (bit position) corresponding to the search pointer is calculated, both endpoints of the range are input to a distribution function indicating the histogram, and density corresponding to the one-dimensional value is obtained from a difference between the values. The range searched by the search pointer in accordance with the density operates so as to reduce a search space by reducing a range to be processed originally.

When the strict accuracy is not required by such an operation in accordance with an object of performing space-filling curve processing, it is possible to omit processing having little influence of omission on the accuracy, and to achieve an object of the present invention.

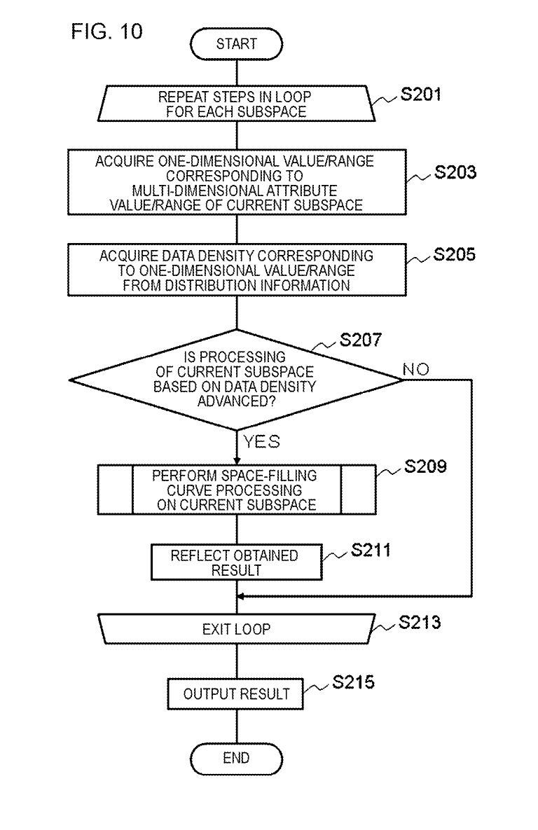

With such a configuration, a space-filling curve processing method of the data processing device 100 in the space-filling curve processing system of the present embodiment will be described below. FIG. 10 is a flow diagram illustrating an example of operations of the space-filling curve processing system according to the present embodiment.

In the space-filling curve processing method of the present embodiment, when performing processing on a subspace of a multi-dimensional space, the data processing device 100 that performs space-filling curve processing on multi-dimensional data associated with a processing objective refers to distribution information indicating the density distribution or cumulative distribution of a data constellation of a plurality of one-dimensional values obtained by performing the space-filling curve processing on the multi-dimensional data, and acquires the data density of a one-dimensional value or range corresponding to the subspace (step S205). The data processing device determines whether to perform space-filling curve processing in accordance with the data density of the subspace (step S207), and performs space-filling curve processing in accordance with a determination result (step S209).

The operations of the space-filling curve processing system according to the present embodiment having such a configuration will be described below.

First, a procedure for generating the distribution information in the data processing device 100 of the space-filling curve processing system according to the present embodiment will be described.

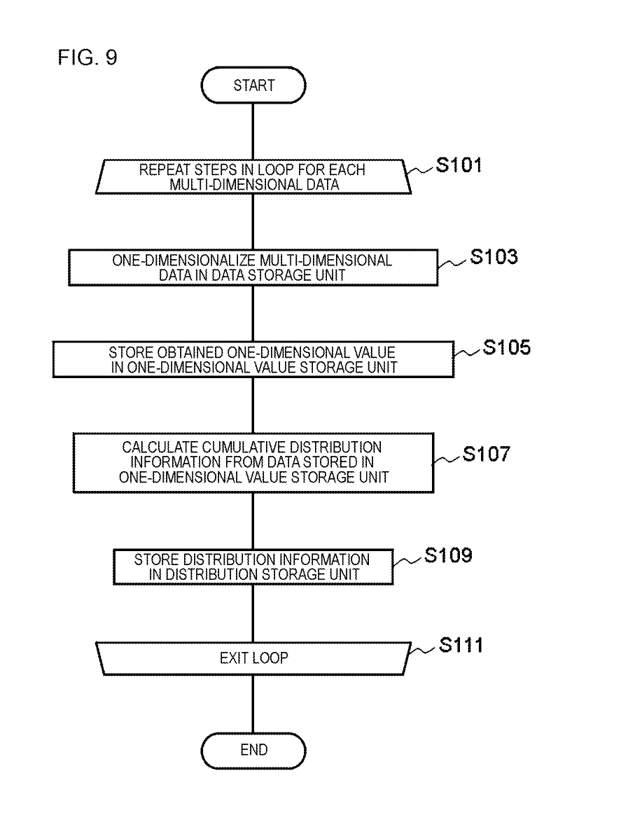

FIG. 9 is a flow diagram illustrating an example of a procedure of a distribution information generation process of the data processing device 100 of the space-filling curve processing system according to the present embodiment. Hereinafter, a description will be given with reference to FIGS. 3 and 9.

Here, a loop process between step S101 to step S111 is repeated for each multi-dimensional data stored in the data storage unit 112. First, the space-filling curve one-dimensionalization unit 114 one-dimensionalizes the multi-dimensional data (step S103). The space-filling curve one-dimensionalization unit 114 stores the obtained one-dimensional value in the one-dimensional value storage unit 116 (step S105). Next, the distribution calculating unit 118 derives cumulative distribution information from the data stored in the one-dimensional value storage unit 116 (step S107), and stores the derived information in the distribution storage unit 102 (step S109).

Next, a description will be given of a procedure when space-filling curve processing is performed on multi-dimensional data associated with a processing objective in the data processing device 100 of the space-filling curve processing system according to the present embodiment.

FIG. 10 is a flow diagram illustrating an example of a procedure of space-filling curve processing of the data processing device 100 of the space-filling curve processing system according to the present embodiment. Hereinafter, a description will be given with reference to FIGS. 1, 3 and 10.

In the present embodiment, in space-filling curve processing for a subspace of a provided multi-dimensional space, a loop process between step S201 to step S213 is repeated with respect to each subspace constituting the subspace.

First, the space-filling curve processing unit 110 acquires a one-dimensional value or a one-dimensional range corresponding to a multi-dimensional attribute value or an attribute range of the current subspace (step S203). The space-filling curve processing unit 110 (data density acquisition unit 104 of FIG. 1) then acquires data density corresponding to the one-dimensional value or the one-dimensional range from distribution information stored in the distribution storage unit 102 (step S205). The space-filling curve processing unit 110 then determines whether to advance processing of the current subspace from the data density (step S207). When the processing is advanced (YES of step S207), the space-filling curve processing unit 110 performs space-filling curve processing recursively using the current subspace as an input (step S209). The processed result is reflected as a result in step S209 (step S211). When the processing is not advanced (NO of step S207), or after step S211, the flow returns to step S201, and a loop process is repeated with respect to the next subspace. When processing for all the subspaces is terminated, the loop process is terminated (step S213). The space-filling curve processing unit 110 outputs a result, and returns the result to a requestor of processing (step S215).

As described above, according to the space-filling curve processing system of the embodiment of the present invention, it is possible to determine to omit processing of a space having small data density, and to thereby realize the speeding up of processing by a reduction in the low accuracy of processing. For example, it is possible to achieve fast response time of processing, such as range retrieval, selectivity estimation, approximate number-of-cases search, and distribution visualization, which is processing of an objective for performing space-filling curve processing. The reason is because when space-filling curve processing for a subspace of a multi-dimensional space is performed, data density corresponding to a subspace during processing can be referred to, and it is determined whether to subdivide and process the subspace in accordance with the data density. In other words, when space-filling curve processing is performed on a certain space, it is possible to determine a deterioration in accuracy when the processing is omitted, by referring to density distribution (histogram) obtained by one-dimensionalizing an original multi-dimensional attribute value through the space-filling curve processing, and to reduce influence on the accuracy by determining a search range using the density distribution as a determination index to thereby perform high-speed processing.

As described above, although the embodiments of the present invention have been set forth with reference to the drawings, they are merely illustrative of the present invention, and various configurations other than those stated above can be adopted.

### EXAMPLE

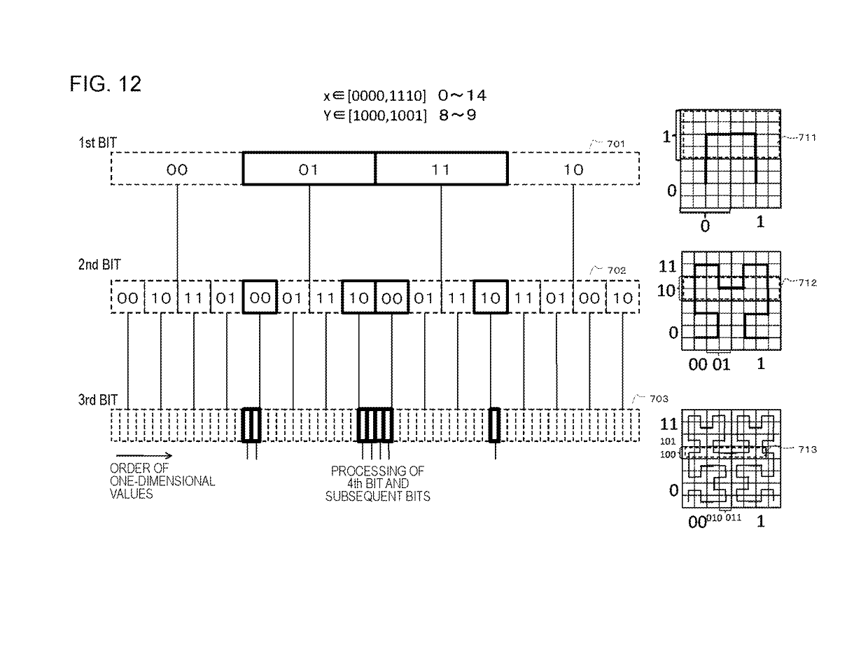

First, as a comparative example to the present example, reference will be made to FIG. 12 to describe processing of obtaining a plurality of one-dimensional ranges corresponding to two-dimensional range retrieval, without considering the data density of distribution information.

Here, each multi-dimensional data is stored in a node of an address of a one-dimensional value calculated. However, in the subsequent stage of the processing of the present invention, original retrieval is applied to data acquired from the node of the address calculated, and determination of whether to be set to a retrieval result is performed. For this reason, a plurality of one-dimensional ranges obtained herein has to include all data items which are originally obtained in the retrieval expression. On the other hand, there is no problem even when data which is not fitted into the retrieval expression is included in the plurality of one-dimensional ranges obtained.

In two-dimensional range retrieval shown in FIG. 12, a first attribute x corresponds to retrieval of the range of 0 to 14, a second attribute y corresponds to retrieval of the range of 8 to 9, and the range of respective bit patterns is set to be [0000, 1110] and [1000, 1001]. Meanwhile, hereinafter, sign “[” and sign “]” indicate a closed interval, and sign “(” and sign “)” indicate an open interval.

In a head bit 701, a range that satisfies 01 and 11 is a retrieval object, and thus a range 711 of FIG. 12 becomes a retrieval object. In the next bit 702, 00 and 10 become retrieval objects with respect to a range of which the head bit 701 is 01, and 00 and 10 become retrieval objects with respect to a range of which the head bit 701 is 11, which corresponds to a range 712 of FIG. 12. In this manner, in the comparative example, it is necessary to retrieve a corresponding one-dimensional range with respect to a total of seven nodes, in a third bit 703. Thus, the obtained retrieval range corresponds to a range 713 of FIG. 12.

Next, an example will be described below. As the example, a description will be given of processing of referring to distribution information, and obtaining a plurality of one-dimensional ranges corresponding to two-dimensional range retrieval in consideration of data density.

Meanwhile, when processing corresponding to a provided multi-dimensional attribute range is performed from a head bit, it is possible to perform processing in a depth-first search and a breadth-first search. In the depth-first search, as a search method of a multi-dimensional attribute space, a bit is advanced first only with respect to one result when a plurality of results are obtained. For example, in a description given with reference to FIG. 10, the space-filling curve processing unit 110 confirms whether the head bit conforms with the condition of the multi-dimensional attribute range (step S207 in a first loop of step S201, and step S209 and step S211 if step S207 is YES). The space-filling curve processing unit 110 first determines a condition regarding a second bit with respect to one result out of the obtained results (step S207 in a second loop of step S201, and step S209 and step S211 if step S207 is YES), and processes a third bit with respect to one more result out of the obtained results (step S207 in a third loop of step S201, and step S209 and step S211 if step S207 is YES).

For example, in the data processing device 100 of the present embodiment, a search list that stores subspaces may be sorted in order of data density and be prepared, the subspaces may be extracted in descending order of density, a subspace that further satisfies a condition among the subspaces may be added, and the next subspace may be extracted again. In order to perform processing within a certain calculation time, processing may be stopped at a point in time when a certain subspace is processed. In order to attain a certain false drop rate, processing may be stopped at a time when data density of which the subspace not satisfying the condition is processed so as to meet the condition is equal to or more than a certain value.

On the other hand, in the breadth-first search, when a plurality of results are obtained, a bit is not advanced forward with respect to a specific result, but processing is advanced so as to handle the same bit as much as possible with respect to all the results. In the breadth-first search, it is possible to realize a false drop rate as low as possible within a certain calculation time, as compared with the depth-first search. Alternatively, it is possible to perform processing within a calculation time as short as possible with a certain false drop rate.

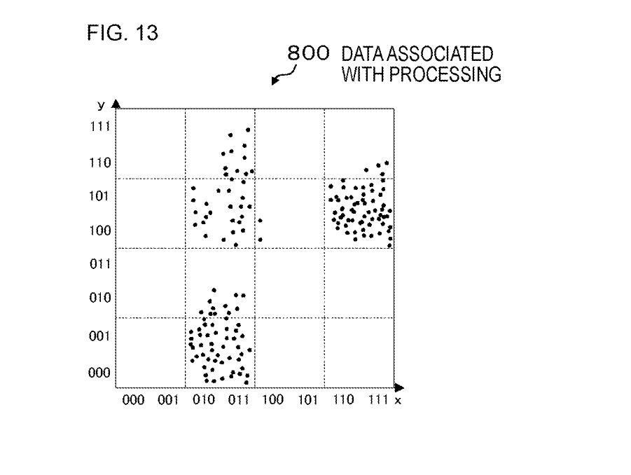

Hereinafter, in the present example, an example of the depth-first search will be described with reference to FIGS. 13 to 15.

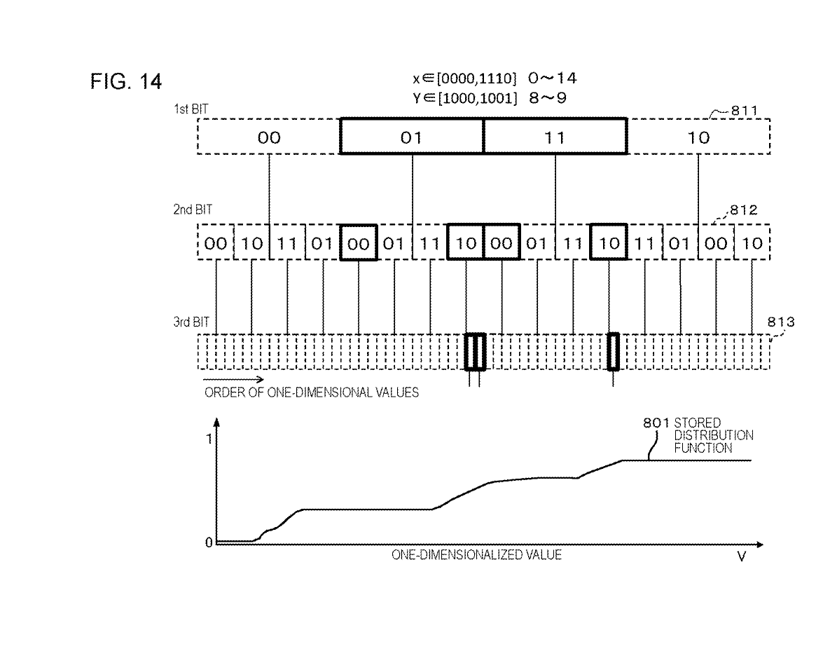

In the present example, it is assumed that the distribution calculating unit 118 (FIG. 3) generates distribution information 801 (FIG. 14) expressed as a distribution function of cumulative distribution, from some of data 800 (FIG. 13) obtained by sampling from data of a retrieval object. An example is shown in which the space-filling curve processing unit 110 performs two-dimensional range retrieval while referring to the distribution information 801.

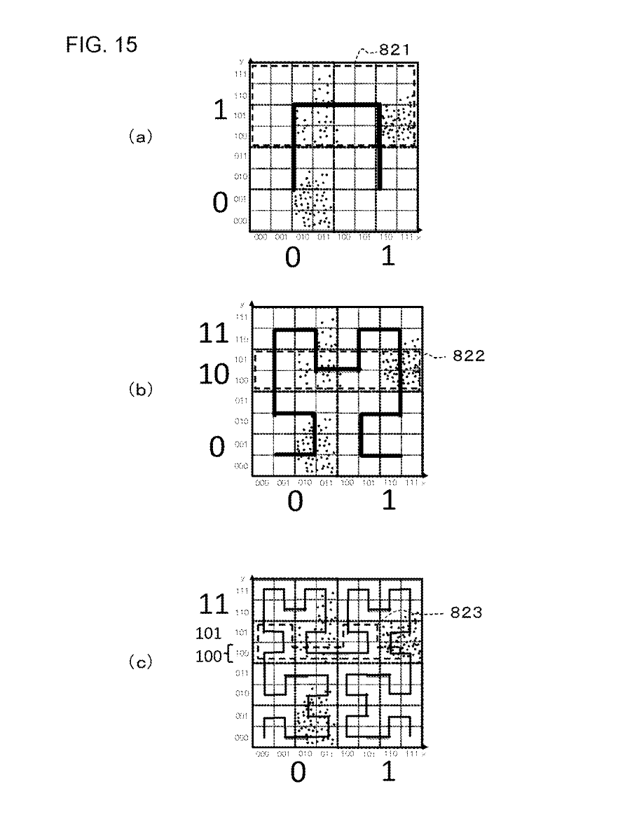

First, in a head bit 811 (FIG. 14), a range 821 (FIG. 15 (a)) that satisfies 01 and 11 becomes a retrieval object, and corresponding one-dimensional bits are 01 and 10, respectively. Next, as similar to the case with FIG. 12, multi-dimensional values of 00 and 10 become retrieval objects with respect to a range of which the multi-dimensional value of the head bit 811 is 01 (corresponding one-dimensional values are 00 and 11), and 00 and 10 become retrieval objects with respect to a range of which the head bit 811 is 11 (corresponding one-dimensional values are 00 and 11). A retrieval range that satisfies these values corresponds to a range 822 of FIG. 15(b).

Here, a value up to a fourth bit of a one-dimensional value having a multi-dimensional value of the head bit 811 of 01 and a second bit 812 (FIG. 14) of 00 is 0100, and a one-dimensional range corresponding to a space made of the subsequent bits becomes [01000000, 01010000). The range becomes [64, 80) in terms of the decimal system. In order to calculate the data density of this range, when values of both ends thereof are input to the cumulative distribution, and a difference therebetween is obtained, the difference becomes 0 in this example. As a result, data density can be determined to be sufficiently low. Thus, processing of further dividing the subspace (the head is 01, and the first bit is 00) is not advanced, but all the subspaces are set to process objects, and processing of the next subspace (the head is 01, and the first bit is 10) is advanced.

Meanwhile, since the processing herein is to output a one-dimensional range corresponding to a multi-dimensional range, all the one-dimensional ranges of [01000000, 01010000) can be regarded to be included in retrieval objects. On the other hand, in the processing of the next subspace (the head is 01, and the first bit is 10), the one-dimensional range of the subspace is [01111000, 10000000), and becomes [120, 128) in terms of the decimal system. When the data density of the range is calculated using the above-mentioned distribution information, a sufficiently large value is obtained, and thus processing to a third bit 813 (FIG. 14) is advanced.

In this manner, data processing is performed while referring to the data distribution. Thus, in a location of which the data density is high, space-filling curve processing is advanced up to a low-order bit, and in a location of which the data density is low, processing for a low-order bit of a space-filling curve is omitted in a high-order bit thereof, and data processing for the entire range is performed.

As described above, in the present example, in consideration of the density data of distribution information, a corresponding one-dimensional range may be retrieved with respect to a total of three nodes, in the third bit 813. As compared with the above comparative example, it is known that the number of nodes serving as retrieval objects is reduced from 7 to 3. Meanwhile, an obtained retrieval range corresponds to a range 823 of FIG. 15(c).

As above, the present invention has been described using the exemplary embodiments and the examples, but the present invention is not limited to the exemplary embodiments and the examples. Configurations and details of the present invention may have various modifications that can be understood by those skilled in the art within the scope of the present invention.

Some or all the above-mentioned embodiments may be described as the following appendices, but is not limited thereto.

### Supplementary Note 1

A space-filling curve processing method in which a data processing device that performs space-filling curve processing on multi-dimensional data associated with a processing objective, and the space-filling curve processing method comprising:

referring to, by the data processing device, when performing processing on a subspace of a multi-dimensional space, distribution information indicating density distribution or cumulative distribution of a data constellation of a plurality of one-dimensional values obtained by performing the space-filling curve processing on the multi-dimensional data, so as to acquire data density of a one-dimensional value or range corresponding to the subspace;

determining, by the data processing device, whether to perform space-filling curve processing in accordance with the data density of the subspace; and

performing, by the data processing device, space-filling curve processing in accordance with the determination result.

### Supplementary Note 2

The space-filling curve processing method according to Supplementary note 1, wherein in a process of subdividing each subspace of the multi-dimensional space and repeatedly performing the space-filling curve processing in a stepwise manner, and the space-filling curve processing method comprises:

performing, the data processing device, subdivision in a stepwise manner only on each subspace of which the data density is equal to or more than a threshold, and repeating the space-filling curve processing a predetermined number of times, and

stopping, the data processing device, the space-filling curve processing without performing further subdivision on each subspace of which the data density is less than a threshold.

### Supplementary Note 3

The space-filling curve processing method according to Supplementary note 2, comprising:

when the processing for the subspace of the multi-dimensional space is a retrieval process of acquiring a plurality of one-dimensional attribute values or ranges corresponding to a multi-dimensional attribute value or range, obtaining, by the data processing device, as retrieval ranges, each subspace in which the space-filling curve processing is stopped in accordance with the data density and each subspace which is obtained by performing the space-filling curve processing the predetermined number of times. cl Supplementary Note 4

The space-filling curve processing method according to any one of Supplementary notes 1 to 3, wherein the data processing device further includes a distribution information storage device, and the space-filling curve processing method comprises:

using, by the data processing device, as an input, a data constellation of a plurality of one-dimensional values obtained by performing space-filling curve processing on multi-dimensional data associated with a processing objective, so as to generate distribution information indicating density distribution or cumulative distribution of the data constellation,

storing, by the data processing device, the generated distribution information in the distribution information storage device, and

referring, by the data processing device, to the distribution information stored in the distribution information storage device, so as to acquire data density of a one-dimensional value or range corresponding to the subspace.

### Supplementary Note 5

A program causing a computer for realizing a data processing device that performs space-filling curve processing to execute:

when performing processing on a subspace of a multi-dimensional space, a procedure for referring to distribution information indicating density distribution or cumulative distribution of a data constellation of a plurality of one-dimensional values obtained by performing space-filling curve processing on multi-dimensional data associated with a processing objective, so as to acquire data density of a one-dimensional value or range corresponding to the subspace;

a procedure for determining whether to perform space-filling curve processing in accordance with the data density of the subspace; and

a procedure for performing the space-filling curve processing in accordance with the determination result of the determination procedure.

### Supplementary Note 6

The program according to Supplementary note 5, causing the computer to further execute:

a procedure for subdividing each subspace of the multi-dimensional space and repeatedly performing the space-filling curve processing in a stepwise manner;

in a process of the procedure for repeatedly performing the space-filling curve processing in a stepwise manner,

a procedure for performing subdivision in a stepwise manner only with respect to each subspace of which the data density is equal to or more than a threshold, and repeating the space-filling curve processing a predetermined number of times; and

a procedure for stopping the space-filling curve processing without performing further subdivision with respect to each subspace of which the data density is less than a threshold.

### Supplementary Note 7

The program according to Supplementary note 6, causing the computer to further execute,

when the processing for the subspace of the multi-dimensional space is a retrieval process of acquiring a plurality of one-dimensional attribute values or ranges corresponding to a multi-dimensional attribute value or range,

a procedure for obtaining, as retrieval range, each subspace in which the space-filling curve processing is stopped in accordance with the data density and each subspace which is obtained by performing the space-filling curve processing the predetermined number of times.

### Supplementary Note 8

The program according to any one of Supplementary notes 5 to 7, wherein the data processing device further includes a distribution information storage device, and

the program causes the computer to further execute:

a procedure for, using, as an input, a data constellation of a plurality of one-dimensional values obtained by performing space-filling curve processing on multi-dimensional data associated with a processing objective, generating distribution information indicating density distribution or cumulative distribution of the data constellation;

a procedure for storing the generated distribution information in the distribution information storage device; and

a procedure for referring to the distribution information stored in the distribution information storage device, and acquiring data density of a one-dimensional value or range corresponding to the subspace.

This application is based upon and claims the benefit of priority from Japanese Patent Application No. 2011-211144, filed Sep. 27, 2011; the entire contents of which are incorporated herein by reference.

1. A space-filling curve processing system comprising:
an acquisition unit that, when performing processing of an objective on a subspace of a multi-dimensional space, refers to distribution information indicating density distribution or cumulative distribution of a data constellation of a plurality of one-dimensional values obtained by performing space-filling curve processing on multi-dimensional data associated with the processing objective, and acquires data density of a one-dimensional value or range corresponding to the subspace;
a determination unit that determines whether to perform space-filling curve processing in accordance with the acquired data density of the subspace; and
a space-filling curve processing unit that performs the space-filling curve processing in accordance with the determination result of the determination unit.

2. The space-filling curve processing system according to claim 1, wherein in a process of subdividing each subspace of the multi-dimensional space and repeatedly performing the space-filling curve processing in a stepwise manner, the space-filling curve processing unit
performs subdivision in a stepwise manner only with respect to each subspace of which the data density is equal to or more than a threshold, and repeats the space-filling curve processing a predetermined number of times, and
stops the space-filling curve processing without performing further subdivision with respect to each subspace of which the data density is less than a threshold.

3. The space-filling curve processing system according to claim 2, wherein when the processing for the subspace of the multi-dimensional space is a retrieval process of acquiring a plurality of one-dimensional attribute values or ranges corresponding to a multi-dimensional attribute value or range,
the space-filling curve processing unit obtains, as retrieval ranges, each subspace in which the space-filling curve processing is stopped in accordance with the data density and each subspace which is obtained by performing the space-filling curve processing the predetermined number of times.

4. The space-filling curve processing system according to claim 1, further comprising:
a distribution calculating unit that, using, as an input, a data constellation of a plurality of one-dimensional values obtained by performing space-filling curve processing on multi-dimensional data associated with a processing objective, generates distribution information indicating density distribution or cumulative distribution of the data constellation; and
a distribution information storage unit that stores the generated distribution information,
wherein the acquisition unit refers to the distribution information stored in the distribution information storage unit, and acquires data density of a one-dimensional value or range corresponding to the subspace.

5. A space-filling curve processing method in which a data processing device that performs space-filling curve processing on multi-dimensional data associated with a processing objective, the space-filling curve processing method comprising:
referring to, by the data processing device, when performing processing on a subspace of a multi-dimensional space, distribution information indicating density distribution or cumulative distribution of a data constellation of a plurality of one-dimensional values obtained by performing the space-filling curve processing on the multi-dimensional data, so as to acquire data density of a one-dimensional value or range corresponding to the subspace;
determining, by the data processing device, whether to perform space-filling curve processing in accordance with the data density of the subspace; and
performing, by the data processing device, space-filling curve processing in accordance with the determination result.

6. The space-filling curve processing method according to claim 5, wherein in a process of subdividing each subspace of the multi-dimensional space and repeatedly performing the space-filling curve processing in a stepwise manner, and the space-filling curve processing method comprises:
performing, by the data subdivision in a stepwise manner only on each subspace of which the data density is equal to or more than a threshold, and repeating the space-filling curve processing a predetermined number of times, and
stopping, by the data processing device, the space-filling curve processing without performing further subdivision on each subspace of which the data density is less than a threshold.

7. The space-filling curve processing method according to claim 6, comprising:
when the processing for the subspace of the multi-dimensional space is a retrieval process of acquiring a plurality of one-dimensional attribute values or ranges corresponding to a multi-dimensional attribute value or range, obtaining, by the data processing device, as retrieval ranges, each subspace in which the space-filling curve processing is stopped in accordance with the data density and each subspace which is obtained by performing the space-filling curve processing the predetermined number of times.

8. A non-transitory computer readable medium for storing a program that, when executed by a computer for realizing a data processing device that performs space-filling curve processing, causes the computer to perform operations comprising:
when performing processing of an objective on a subspace of a multi-dimensional space, referring to distribution information indicating density distribution or cumulative distribution of a data constellation of a plurality of one-dimensional values obtained by space-filling curve processing on multi-dimensional data associated with the processing objective, and acquiring data density of a one-dimensional value or range corresponding to the subspace;
determining whether to perform space-filling curve processing in accordance with the data density of the subspace; and
performing the space-filling curve processing in accordance with a determination result of the determining operation.

9. The non-transitory computer readable medium according to claim 8, wherein the operations performed by the computer further comprise:
subdividing each subspace of the multi-dimensional space and repeatedly performing the space-filling curve processing in a stepwise manner;
repeatedly performing the space-filling curve processing in a stepwise manner, wherein the repeatedly performing the space-filling curve processing in a stepwise manner comprises:
performing subdivision in a stepwise manner only with respect to each subspace of which the data density is equal to or more than a threshold, and repeating the space-filling curve processing a predetermined number of times; and
stopping the space-filling curve processing without performing further subdivision with respect to each subspace of which the data density is less than a threshold.

10. The non-transitory computer readable medium according to claim 9, wherein the operations performed by the computer further comprise:
when the processing for the subspace of the multi-dimensional space is a retrieval process of acquiring a plurality of one-dimensional attribute values or ranges corresponding to a multi-dimensional attribute value or range,
obtaining, as retrieval range, each subspace in which the space-filling curve processing is stopped in accordance with the data density and each subspace which is obtained by performing the space-filling curve processing the predetermined number of times.
